(19) United States
(12) Patent Application Publication
(10) Pub. No.: US 2017/0088041 A1
(43) Pub. Date: Mar. 30, 2017

(54) Safety Belt Warning Flashers

(71) Applicant: Demond Eugene Johnson, Goldsboro, NC (US)

(72) Inventor: Demond Eugene Johnson, Goldsboro, NC (US)

(21) Appl. No.: 15/276,729

(22) Filed: Sep. 26, 2016

Related U.S. Application Data
(60) Provisional application No. 62/232,465, filed on Sep. 25, 2015.

(51) Int. Cl. B60Q 1/50

(52) U.S. Cl. CPC B60Q 1/50

(57) ABSTRACT

A device is provided for communicating one or more pieces of information about a vehicle to a police officer or other law enforcement employee, wherein said pieces of information are selected from the group consisting of: a. vehicle ID number, b. identity of vehicle owner, c. whether or not registration fees for the vehicle have been paid, and d. insurance information about the vehicle, and wherein such communication happens through the device transmitting said information via a wireless method to a computer device in the possession of said police officer or other law enforcement employee, and wherein said device includes a computer memory on which is stored said pieces of information. Systems and processes utilizing said device are also provided.

### CROSS-REFERENCE TO RELATED APPLICATIONS

This application claims priority to U.S. Provisional Application No. 62/232,465 filed Sep. 25, 2015, the disclosure of which is herein incorporated by reference in its entirety for all purposes.

### BACKGROUND

The United States, and other countries, have high numbers of avoidable traffic fatalities that happen when automobile passengers and drivers do not put on their seatbelts, and are involved in automobile accidents. Every state has enacted laws requiring automobile occupants to wear their seatbelts when the automobile is in motion. This has reduced the number of avoidable traffic deaths, but the number of avoidable traffic deaths is still very high. Safety belt use in automobiles increased from 55% in 1994 to 82% in 2005, but still thousands of Americans suffered avoidable deaths in automobile crashes.

The National Highway Traffic Safety Administration states that in 2004, 31,693 people died in automobile crashes in the United States. 55% of these were not wearing safety belts at the time. In 2009, 2.3 million adult Americans were treated in rooms for injuries that resulted from their not wearing their safety belts, and motor vehicles are presently the main cause of death for people aged 5-34 in the United States.

Regular safety belt use is the most effective, and cheapest, way to reduce deaths and injuries resulting from automobile crashes.

Numerous government agencies and private companies have noticed this problem. For example, seventy-fiver percent of passengers who are in an automobile crash, and who have safety belts buckled, survive the crash. Safety belts reduce deaths and injuries in automobile crashes by about 50%.

Air bags also provide protection but are not a substitute for seat belts, and air bags can also be dangerous to children because of the force with which they deploy.

Police officers and others often will not know whether occupants of a vehicle are wearing safety belts until an automobile crash happens. Clearly an invention is needed which warns police officers and others that the occupants of an automobile are not wearing safety belts.

In addition, when making a traffic stop, law enforcement officers often have to manually write down the license plate number of a vehicle, and then check this number by typing it into a computer, and then wait for a response from the computer, which will tell the officer who the registered owner of the vehicle is, whether or not the vehicle is insured, whether the vehicle has been stolen, and other information about the vehicle. This approach has problems, however, because the officer will often not be able to check the information about the vehicle until he has stopped it and spoken to the passengers. If the passengers are criminals, then they could hurt the officer if he or she approaches the vehicle without knowing that they are criminals. Police officers have been killed during “routine” traffic stops, when the vehicles being stopped were stolen or occupied by criminals. An invention is needed which will allow a police officer or other law enforcement officer to check the information connected to a vehicle's license plate or vehicle identification number (VIN number) without having to physically stop the vehicle.

Insurance companies also often cannot tell, after the fact, whether an injured vehicle crash victim was wearing a safety belt. This is important for assigning “fault” for purposes of injury. Insurance companies also need a better method of encouraging their insured to “buckle up” and wear their safety belts when inside a moving vehicle. An invention is needed which can help insurance companies to reconstruct which occupants of a vehicle were wearing safety belts when a crash happens. There is also a need for an invention that will tell insurance companies whether their insured are wearing their safety belts.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one embodiment, a device is provided for communicating one or more pieces of information about a vehicle to a police officer or other law enforcement employee, wherein said pieces of information are selected from the group consisting of: a. vehicle ID number, b. identity of vehicle owner, c. whether or not registration fees for the vehicle have been paid, and d. insurance information about the vehicle, and wherein such communication happens through the device transmitting said information via a wireless method to a computer device in the possession of said police officer or other law enforcement employee, and wherein said device includes a computer memory on which is stored said pieces of information. In some embodiments the device is encased in a reinforced case that may be attached to the bumper of the vehicle. In other embodiments, said device also includes a component that flashes. In other embodiments, the pieces of information stored in said computer memory may be updated by a user with the appropriate authorization.

According to another embodiment, a system is provided for informing individuals outside a vehicle about whether the occupants of the vehicle are wearing their safety belts while the vehicle is moving, comprising: one or more monitoring sensors, each of which is capable of sensing whether a seatbelt has been buckled and whether the automobile is moving; a transmitting mechanism attached to each of the monitoring sensors; and a broadcast mechanism which has an impact-resistant outer surface; wherein said transmitting mechanisms are each capable of transmitting information to the broadcast mechanism. In some embodiments the information is selected from the group consisting of: whether the safety belt monitored by the monitoring sensor is fastened, whether there is a vehicle occupant sitting in the seat associated with said safety belt, and when said vehicle is moving and one or more of said safety belts is not fastened when an occupant is sitting in the seat associated with said safety belt. In another embodiment the broadcast mechanism is located on the outside of the vehicle. In another embodiment, said broadcast mechanism includes a flashing light that flashes when said vehicle is moving. In another embodiment, the broadcast mechanism receives a signal from one or more of said transmitting mechanisms that one or more of said seatbelts is unfastened when an occupant is occupying the seat associated with said seatbelt. In another embodiment, the flashing light has the logo of an automobile maker in its center.

According to another embodiment, a process is provided for communicating one or more pieces of information about a vehicle to police officers by making said information available in a device with a computer memory and a wireless transmitting capability, so that said device is capable of transmitting said pieces of information to a computer or equivalent machine possessed by said police officer; where said information is one or more pieces of information selected from the group consisting of: a. vehicle ID number; b. identity of vehicle owner; c. whether or not registration fees for the vehicle have been paid; and d. insurance information about the vehicle; and wherein said device is encased in a reinforced case. In some embodiments the device is attached to the bumper of the vehicle. In other embodiments, the device includes a flashing light, particularly wherein the flashing light flashes red. In other embodiments, said computer memory can be reprogrammed to reflect changes in said pieces of information. In other embodiments, magnetic sensors are electronically coupled to said device, wherein said sensors inform said device of whether a person has sat in one of the seats inside the vehicle and has not fastened the seatbelt. In other embodiments, said device has a flashing light attached, wherein said flashing light flashes when a person has sat in one of the seats inside the vehicle and has not fastened the seatbelt.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1A shows one possible embodiment of the broadcast mechanism (1).

FIG. 1B shows another possible embodiment of the broadcast mechanism (1).

FIG. 2 is a “cut-away” view of an automobile, with views of the way that the monitoring sensors (3) are placed inside the seat belt couplings (4).

FIG. 3 is a “cut-away” view of an automobile from the top, with the monitoring sensors (3) inside the seats next to the seatbelts.

FIG. 4 is a “cut-away” view of the automobile from FIG. 3, with passenger occupants.

FIG. 5 shows the back of an automobile with one possible location for the broadcast mechanism (1), upon the back of the automobile near the license plate.

FIG. 6 shows the interior of a police car, with a police officer monitoring the broadcast from the broadcast mechanism of an automobile.

FIG. 7 is a “close-up” view of the police officer's laptop screen, and what the police officer will see there.

FIG. 8 is a cross-section of one possible embodiment of a broadcast mechanism (1). The chip (6) can be seen, and is connected to a computer memory (7).

### DETAILED DESCRIPTION

As used herein, the terms “seatbelt” or “safety belt” are interchangeable. In addition, although reference is made to police officers or other law enforcement employees, it is to be understood that the device, systems, and processes described herein may be used to convey information to any individual outside of the vehicle.

The basic design of the invention includes a device (The “broadcast mechanism”) (1) positioned on the outside of a vehicle, such as an automobile. The device may be protected by an impact resistant covering. The broadcast mechanism may also include a flashing light (2), which only flashes when the vehicle is moving and one of the occupants of the vehicle has taken off his or her safety belt. Inside the flashing light, the logo of the automobile maker may be provided, and may serve to make the flashing light more noticeable.

The broadcast mechanism may include a computer chip (6), and a computer memory (7), and a component (The “reception component”) capable of receiving electronic signals via radio waves or another technology. The reception component receives electronic signals from sensors inside the safety belt mechanisms of the vehicle, or alternatively inside the seats of the vehicle. They may be placed in other locations within the vehicle, as long as they are capable of monitoring whether vehicle occupants have fastened their seatbelts. These chips are referred to herein as the monitoring sensors (3).

Each of the monitoring sensors are capable of confirming whether the person sitting in the seat with the seatbelt mechanism that this particular monitoring sensor is examining, has fastened his or her safety belt. The monitoring sensor may directly confirm this, or may be connected to a computer chip, referred to herein as the monitoring chip.

In one possible design, the monitoring sensors (3) are included in the seatbelt couplings, as illustrated in the drawings. Each of the monitoring sensors (3) have a transmitting mechanism (5) that is capable of transmitting information to the broadcast mechanism (1).

When the vehicle is in motion and the seatbelt that one of the monitoring sensors (3) is attached to is fastened, the transmitting mechanism (5) attached to that monitoring sensor transmits this information to inform the broadcast mechanism (1) that the seatbelt is fastened. If the seatbelt is not fastened, the transmission mechanism will inform the broadcast mechanism, and the computer chip in the broadcast mechanism will cause the flashing light to flash. This is true of each of the monitoring sensors. In another possible design, the monitoring sensors can send signals to the monitoring chip(s), which the monitoring chip will use to determine whether the occupant has fastened his or her safety belt. The signals may be sent by either a wired or a wireless connection.

The monitoring chips send electronic signals to the reception component, and when the vehicle is moving and one of the occupants has not fastened his or her safety belt, the monitoring chips informs the reception component. The reception component then communicates with the computer chip, which activates a flashing light, which is visible to law enforcement officers and others outside the vehicle. The law enforcement officers who are watching will then know that one of the vehicle's occupants has unbuckled his or her safety belt, and will pull the vehicle over to issue that occupant a warning or citation.

In particular embodiments, the broadcast mechanism is impact resistant, includes a flashing light, and the light only flashes when one of the seatbelts in the vehicle is not fastened and the vehicle is in motion, and that the broadcast mechanism be capable of communicating either directly or indirectly with the monitoring sensors.

The monitoring sensors may also be located in another area of the automobile, where they are capable of sensing whether the seatbelts in the vehicle are not fastened, while the vehicle is in motion. For example, the monitoring sensors can be located in the seats.

The monitoring sensors may also each involve a computer chip themselves, or may rely on another, simpler mechanism for discerning whether the seatbelts are fastened.

The monitoring sensors could also potentially work by sensing the proximity of components of the seat belt buckle to the sensor, when such proximity is only possible if the seatbelt is buckled.

The monitoring sensors could also function based on magnetically sensing when metal is near, when such metal will only be near enough to a monitoring sensor to trigger that sensor when the seatbelt is buckled. The monitoring sensors could also work in other ways as will be appreciated by those of skill in the art.

The broadcast mechanism also may have a shape other than the shapes shown in the drawings.

The broadcast mechanism is capable of storing and broadcasting other information.

For example, the broadcast mechanism can include a computer memory (7) connected to the chip (6), which will store information such as the vehicle owner, vehicle registration information, VIN number, and license plate number of the vehicle, and insurance information. The computer memory (7) can also store additional information about the owner of the vehicle, and this information can be the information that an officer would get by “running the vehicle's license plates”.

Police patrol officers can then be equipped with radio receivers or other devices that can monitor the broadcasts created by the broadcast device. The receiver can he connected to an officer's laptop, with the ability to transmit information between the receiver and the laptop, so that the officer can simply press a button on his laptop and learn the information that he would get by running the license plates of the automobile. The transmissions from the broadcast instrument can be encrypted so that they can only be read by police vehicles. The technology for these encrypted communications, and to build a receiver of the type needed, which will be connected to the officer's laptop, already exists and is well-known in the prior art.

The information in the computer memory can be encrypted or otherwise protected so that only the State Department of Motor Vehicles or another authorized government entity can change it.

In another embodiment of the invention, the computer memory can be stored in another area of the automobile, where it is more physically protected, and can be connected to a means for transmitting information to the computer chip in the broadcast mechanism. The broadcast mechanism can then broadcast this information. This makes the information less vulnerable to tampering.

In another embodiment of the invention, the information stored in the computer memory will be simply a code that a police officer can use to unlock a database, accessible over the internet, and accessible only to police officers, where the information that the officer would get by “running the automobile's plates” is stored. This will reduce the chances of the information such as the vehicle's VIN number, etc. being tampered with.

In all of the embodiments listed above, the information such as the vehicle owner, vehicle registration information, VIN number, and license plate number of the vehicle, and insurance information can be encrypted so that it can only be changed by the State Department of Motor Vehicles or another authorized government entity. Certain embodiments of the invention also carry additional protections, as noted above.

In all of the embodiments listed above, a police officer will be able to get substantial information about an automobile quickly and easily, without the officer leaving his own automobile. This is an improvement over current technology, where an officer has to follow an automobile closely to read its license plates, or alternatively stop the automobile, before being able to “run its plates”.

The computer memory could also include other information, if desired.

The computer memory could also be configured to store information for a period of time about whether one of the occupants of the automobile had failed to buckle his or her safety belt at the time that the automobile was been moving. This may help an insurance company for assessing fault if the automobile is involved in a crash.

It is possible to create an embodiment of the invention that only informs police officers when the vehicle is in motion and one of the seatbelts is not fastened, and does not broadcast information such as the vehicle's VIN number, etc. Likewise, it is possible to create an embodiment of the invention that only broadcasts information such as the vehicle's VIN number, etc., and does not inform police officers when the vehicle is in motion and one of the occupants has not fastened his or her seatbelt.

In another embodiment of the invention, there are direct wire connections between the monitoring sensors and the broadcast mechanism.

In another embodiment of the invention, the broadcast mechanism (1) only broadcasts information such as the VIN number, insurance information, etc. in response to an electromagnetic beam such as a radio beam from a police car. This beam can contain encrypted identifying information, so that the chip (6) recognizes the electromagnetic beam as coming from a police car. This reduces the possibility of “hackers” monitoring the information that is being broadcast by the broadcast mechanism.

In still another embodiment of the invention, the broadcast mechanism (1) can broadcast a picture showing which passenger has not fastened his or her seatbelt. The broadcast mechanism can broadcast this information only in response to an electromagnetic beam from a police car, or can broadcast this information whenever the vehicle is in motion, or can be pre-programmed to broadcast this information in some other set of circumstances.

The technology to make the broadcast mechanism impact-resistant is presently available in the prior art.

Whether or not the vehicle is moving can be sensed by the monitoring sensors (3) in some embodiments. Alternatively, it can be sensed by the computer chip (6) or some other component of the broadcast mechanism (1) in some embodiments. This information can also be sensed by some other component of the vehicle and communicated to either the monitoring sensors (3) or the broadcast mechanism (1) in other embodiments.

Insurance companies will have an additional use for the device described herein, because they will be able to directly monitor which of their insured is actually wearing safety belts. They can then give reduced insurance rates to drivers who wear safety belts.

This invention can also be used on trucks, jeeps, or any other type of vehicle that has seatbelts.

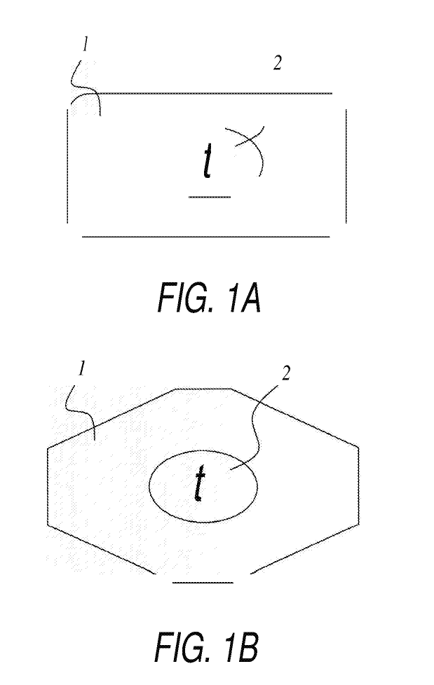

Turning now to the figures, FIG. 1A shows one possible embodiment of the broadcast mechanism (1). It will be placed on the back of an automobile, near the license plate. The flashing light (2) is shown in the center of the broadcast mechanism. It will only flash when the vehicle that it is attached to is being driven, and one of the seats is occupied, and the seatbelt is not fastened. A logo is in the center of the flashing light in this drawing. This is for demonstration purposes only. The logo of any vehicle manufacturer can be placed in the center of the flashing light. Here, the broadcast mechanism (1) is roughly in the shape of a square with rounded corners.

FIG. 1B shows another possible embodiment of the broadcast mechanism (1). It will be placed on the back of an automobile, near the license plate. The flashing light (2) is shown in the center of the broadcast mechanism. It will only flash when the vehicle that it is attached to is being driven, and one of the seats is occupied, and the seatbelt is not fastened. A logo is in the center of the flashing light in this drawing. This is for demonstration purposes only. The logo of any vehicle manufacturer can be placed in the center of the flashing light. Here, the broadcast mechanism (1) is roughly in the shape of an Octagon.

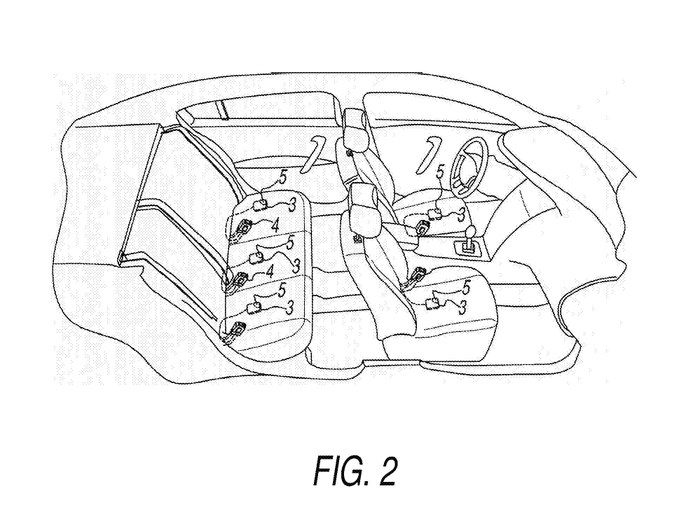

FIG. 2 is a “cut-away” view of an automobile, with views of the way that the monitoring sensors (3) are placed inside the seat belt couplings (4). Several monitoring sensors (3) can be seen. Each of them is next to one of the seat belt couplings (4) that it is intended to be inserted into. Each monitoring sensor (3) also includes a transmitting mechanism (5) that has the ability to transmit to the broadcast mechanism (1) and inform the broadcast mechanism of whether the seatbelt related to that particular monitoring sensor (3) is fastened or not.

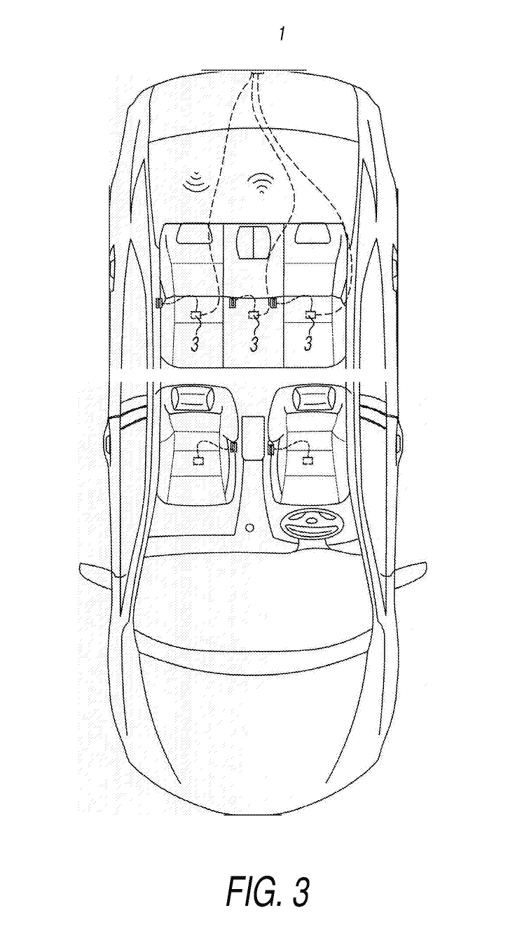

FIG. 3 is a “cut-away” view of an automobile from the top, with the monitoring sensors (3) inside the seats next to the seatbelts. The monitoring sensors (3) are able to communicate with the broadcast mechanism (1) and each monitoring sensor can inform the broadcast mechanism of whether the seatbelt related to the seat where that that monitoring sensor is located is fastened, or not.

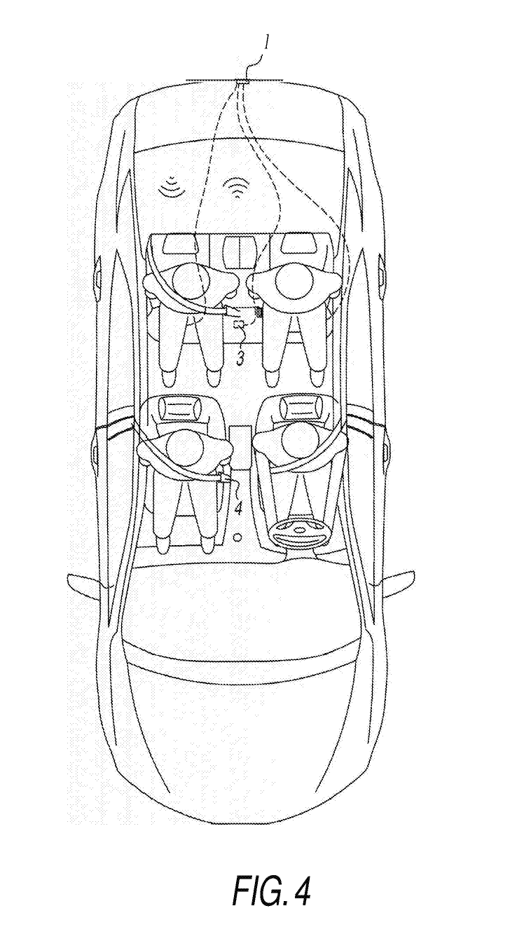

FIG. 4 is a “cut-away” view of the automobile from FIG. 3, with passenger occupants. In this embodiment, the passenger sits in the seat, the pressure on the seat informs the sensor that someone is sitting in the seat, and the sensor waits for the “click” created by the seatbelt fastening, to discern that the seatbelt applicable to that seat has been fastened. The sensor sends this information wirelessly to the broadcast mechanism (1). If the automobile has started moving and one of the seatbelts is not fastened, the flashing red light (2) will flash to make a warning of this.

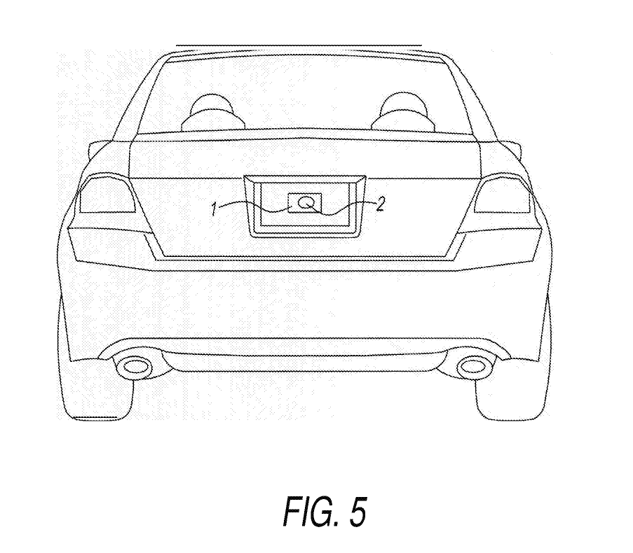

FIG. 5 shows the back of an automobile with one possible location for the broadcast mechanism (1), upon the back of the automobile near the license plate. The flashing light (2) can also be seen.

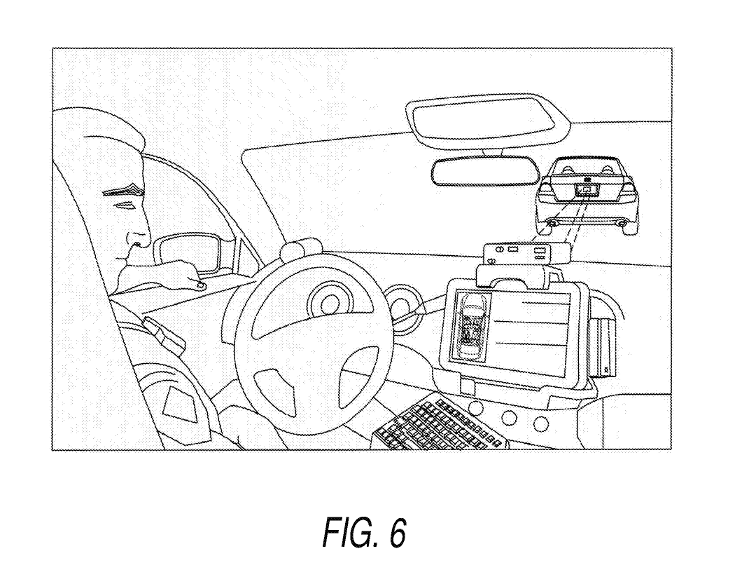

FIG. 6 shows the interior of a police car, with a police officer monitoring the broadcast from the broadcast mechanism of an automobile. The police car is receiving a beam from the broadcast component (1) on the back of an automobile. The broadcast includes a visual depiction that contains information about which of the passengers is not wearing a safety belt. Furthermore, the broadcast includes information about the vehicle such as vehicle ID number, etc. This information is displayed on the in-vehicle laptop of the police officer.

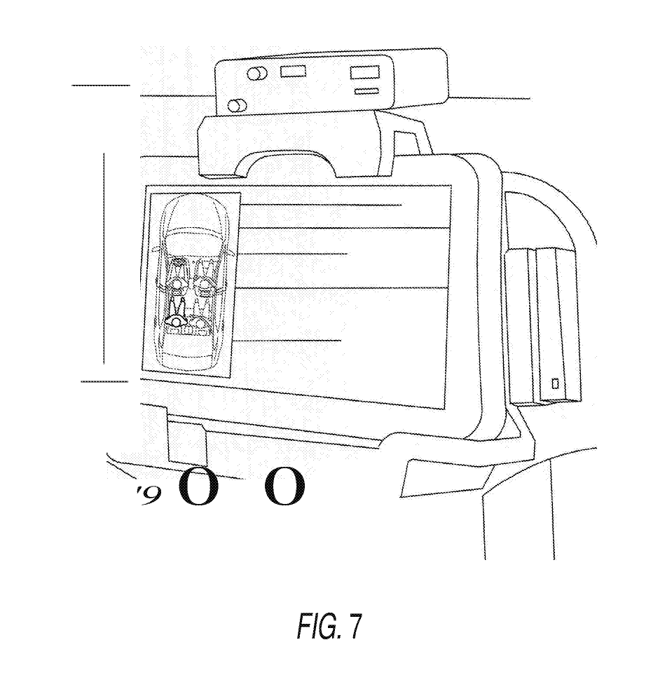

FIG. 7 is a “close-up” view of the police officer's laptop screen, and what the police officer will see there. There is a schematic of the automobile, which pinpoints exactly which passenger does not have his seatbelt fastened. There is also other information about the automobile.

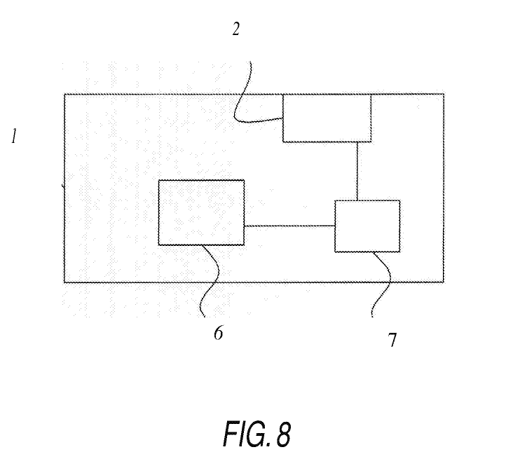

FIG. 8 is a cross-section of one possible embodiment of a broadcast mechanism (1). The chip (6) can be seen, and is connected to a computer memory (7). They are both safe from automobile crashes because they are inside the impact-resistant surface of the broadcast mechanism (1). The chip is also connected to the flashing light (2) and causes it to flash when the vehicle is moving and one of the seatbelts for an occupied seat is not fastened.

It will be understood that terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A device is provided for communicating one or more pieces of information about a vehicle to a police officer or other law enforcement employee, wherein said pieces of information are selected from the group consisting of: a. vehicle ID number, b. identity of vehicle owner, c. whether or not registration fees for the vehicle have been paid, and d. insurance information about the vehicle, and wherein such communication happens through the device transmitting said information via a wireless method to a computer device in the possession of said police officer or other law enforcement employee, and wherein said device includes a computer memory on which is stored said pieces of information.

2. The device of claim 1, wherein the device is encased in a reinforced case.

3. The device of claim 1, wherein the device is attached to the bumper of the vehicle.

4. The device of claim 1, wherein the device further comprises a component that flashes.

5. The device of claim 1, wherein the pieces of information stored in said computer memory are capable of being updated by a user with the appropriate authorization.

6. A system for informing individuals outside a vehicle about whether the occupants of the vehicle are wearing their safety belts while the vehicle is moving, comprising:
one or more monitoring sensors, each of which is capable of sensing whether a seatbelt has been buckled and whether the automobile is moving;
a transmitting mechanism attached to each of the monitoring sensors; and
a broadcast mechanism which has an impact-resistant outer surface;
wherein said transmitting mechanisms are each capable of transmitting information to the broadcast mechanism.

7. The system of claim 6, wherein the information is selected from the group consisting of:
whether the safety belt monitored by the monitoring sensor is fastened, whether there is a vehicle occupant sitting in the seat associated with said safety belt, and when said vehicle is moving and one or more of said safety belts is not fastened when an occupant is sitting in the seat associated with said safety belt.

8. The system of claim 6, wherein the broadcast mechanism is located on the outside of the vehicle.

9. The system of claim 6, wherein the broadcast mechanism includes a flashing light that flashes when said vehicle is moving.

10. The system of claim 6, wherein the broadcast mechanism receives a signal from one or more of said transmitting mechanisms that one or more of said seatbelts is unfastened when an occupant is occupying the seat associated with said seatbelt.

11. The system 6, wherein the flashing light has the logo of an automobile maker in its center.

12. A process for communicating one or more pieces of information about a vehicle to police officers by making said information available in a device with a computer memory and a wireless transmitting capability, wherein said device is capable of transmitting said pieces of information to a computer or equivalent machine possessed by said police officer; and wherein said information is one or more pieces of information selected from the group consisting of: a. vehicle ID number; b. identity of vehicle owner; c. whether or not registration fees for the vehicle have been paid; and d. insurance information about the vehicle.

13. The process of claim 12, wherein said device is encased in a reinforced case.

14. The process of claim 12, wherein the device is attached to the bumper of the vehicle.

15. The process of claim 12, wherein the device comprises a flashing light.

16. The process of claim 15, wherein said flashing light flashes when a person has sat in one of the seats inside the vehicle and has not fastened the seatbelt

17. The process of claim 15, wherein the flashing light is red.

18. The process of claim 12, wherein said computer memory is capable of being reprogrammed to reflect changes in said pieces of information.

19. The process of claim 12, wherein magnetic sensors are electronically coupled to said device.

20. The process of claim 19, wherein said magnetic sensors inform said device of whether a person has sat in one of the seats inside the vehicle and has not fastened the seatbelt.
